(19) United States
(12) Patent Application Publication
(10) Pub. No.: US 2020/0142758 A1
(43) Pub. Date: May 7, 2020

(54) Utilization And Load Metrics For An Event Loop

(71) Applicant: NodeSource, Inc., San Francisco, CA (US)

(72) Inventors: Trevor Norris, Salt Lake City, UT (US); Roderick Vagg, Farmborough Height (AU)

(21) Appl. No.: 16/178,222

(22) Filed: Nov. 1, 2018

(51) Int. Cl. G06F 9/54; G06F 11/30

(52) U.S. Cl. CPC G06F 9/542; G06F 11/3024

(57) ABSTRACT

Systems, methods, and devices for determining a loop iteration utilization metric and an event loop load metric of an event loop are disclosed. A method includes determining a plurality of states of an event loop by sampling the event loop a plurality of times over a sampling period, wherein the state of the event loop consists of a processing state or an idling state. The method includes aggregating the plurality of states of the event loop. The method includes calculating an aggregate state metric and calculating a period loop utilization for the event loop based on the aggregate state metric and a quantity of times the event loop was sampled over the sampling period.

### TECHNICAL FIELD

The present disclosure relates to computing resources metrics and particularly relates to metrics pertaining to an event loop.

### BACKGROUND

Applications and processes with sustained high-volume workloads, various transaction sizes, and other input/output-intensive environments are prevalent across numerous industries. High-performance environments may involve varying requirements for data storage but may have active workloads with a large number of transactions of various sizes or a smaller number of transactions requiring high bandwidth. Such high-performance environments may be optimized by scaling processing resources up or down based on loop iteration utilization and event loop load metrics that are determined at runtime.

Systems using an event-driven programming construct can be utilized in high-volume workloads with one or more clients. Certain event-driven systems include an event loop where the caller is decoupled from the response such that processing resources may be utilized efficiently for asynchronous operations. In the event loop, a request is made to an event provider, and when an event arrives it is passed to a user supplied callback via an event handler for processing. The event loop is a resource allocation mechanism that includes loop idle time and loop processing time. The systems, methods, and devices disclosed herein provide an improved approach to capturing loop iteration utilization and event loop load metrics and scaling computing resources up or down based on such runtime metrics.

### BRIEF DESCRIPTION OF THE DRAWINGS

Non-limiting and non-exhaustive implementations of the present disclosure are described with reference to the following figures, wherein like reference numerals refer to like or similar parts throughout the various views unless otherwise specified. Advantages of the present disclosure will become better understood with regard to the following description and accompanying drawings where:

FIG. 1 is a schematic block diagram of a system for processing events through an event loop, according to one embodiment of the disclosure;

FIG. 2 is a schematic block diagram of an example event loop, according to one embodiment of the disclosure;

FIG. 3 is a schematic block diagram of an example event loop, according to one embodiment of the disclosure;

FIG. 4 is a schematic block diagram of an example event loop, according to one embodiment of the disclosure;

FIG. 5 is a schematic block diagram of an example process for determining metrics for an event loop, according to one embodiment of the disclosure;

FIG. 6 is a schematic block diagram of an example process for determining metrics for an event loop by sampling, according to one embodiment of the disclosure;

FIG. 7 is a schematic block diagram of an example process for determining metrics for an event loop by timeseries data, according to one embodiment of the disclosure;

FIG. 8 is a schematic flow chart diagram of a method for determining a loop iteration utilization, according to one embodiment of the disclosure;

FIG. 9 is a schematic flow chart diagram of a method for determining an event loop load, according to one embodiment of the disclosure;

FIG. 10 is a schematic flow chart diagram of a method for determining a loop processing time, according to one embodiment of the disclosure;

FIG. 11 is a schematic flow chart diagram of a method for determining a period processing time, according to one embodiment of the disclosure;

FIG. 12 is a schematic flow chart diagram of a method for determining a period loop utilization, according to one embodiment of the disclosure; and

FIG. 13 is a block diagram depicting an example computing device or system consistent with one or more embodiments disclosed herein.

### DETAILED DESCRIPTION

The resource utilization of computers and networked computing infrastructure may be improved by monitoring the infrastructure of an application by collecting application runtime data regarding individual software components that are invoked in the application. In an event-driven programming construct involving an event loop, a loop iteration utilization metric or an event loop load metric may be determined that indicates an approximation of proportional use of available resources. The loop iteration utilization metric and the event loop load metric may be used to trigger auto-scaling events to scale application cluster resources both up and down to meet demand with improved fidelity compared with known metrics such as central processing unit (CPU) usage. The loop iteration utilization or the event loop load metrics may also be used to inform load balancing mechanisms to distribute work across a cluster of processes according to their ability to handle additional work. When used in conjunction with CPU usage, the loop iteration utilization metric and the event loop load metric may indicate whether an application has reached its resource limit due to application code limitations or due to amount of resources allocated to the process.

Systems, methods, and devices are disclosed for monitoring runtime data and generating event loop metrics for enhancing capacity planning and efficiency. In certain applications of the disclosure, an event loop is a key resource allocation mechanism for measuring an ability to process additional events. Specifically, the disclosures herein may be applied to a Node.js event loop. It should be appreciated that the disclosures presented herein may be implemented on any suitable system, and particularly on any suitable event loop system, and need not be implemented in Node.js. For many typical Node.js applications, a majority of execution time is spent waiting for network, file systems, and database transactions to complete. Node.js may handle high request volumes due to asynchronous input/output methods that allow simultaneous requests to be served during the time it takes for a read/write to complete.

Under continuous high workload, it can be critical to know the performance and health of applications to ensure proper scaling of computing resources and distribution of load. Many high input/output cases develop scalability issues, so ensuring visibility in performance metrics may be critical to detecting and resolving issues before those issues cause a major system failure or denial of service. In certain implementations, the solution to scaling gracefully may be to create more instances of an application, distribution across multiple processes and/or computing devices, or other changes to architecture. However, without insight into the behavior of an application, it is challenging to identify and implement the base case-specific solution. The methods, systems, and devices disclosed herein provide enhanced visibility into application behavior and overall system health with performance metrics captured at runtime. The performance metrics disclosed herein provide improved view of how code behaves in a production environment.

In an embodiment, a loop iteration utilization is a calculation that may be used for determining the capacity of an event loop to handle additional events. The loop iteration utilization metric monitors the usage of allocating computing resources. In an embodiment, the loop iteration utilization is a numeric metric in the range of zero to one that indicates a proportional measure of how occupied the event loop is when not waiting for an event. This value may indicate “processing” in some form but may be blocked in another manner. A value of one may indicate that the event loop is being used at maximum capacity and a value of zero may indicate a completely idle state. Any value between zero and one may indicate an approximation of proportional use of the event loop. The loop iteration utilization does not measure process idleness in the same manner as central processing unit (CPU) usage. In an embodiment, the loop iteration utilization is measured in terms of an amount of time spent not blocking an event loop from proceeding with additional event processing. The loop iteration utilization is unlike process CPU usage, which may exceed a value of one and thus provide less reliable metrics when measuring the processing limits of the event loop.

Loop iteration utilization may be expressed in timeseries form as an event loop load metric. Event loop load may be calculated at regular time intervals by inspecting event loop instrumentation used to calculate loop iteration utilization. By converting loop iteration utilization to a timeseries metric in the form of period loop utilization, and further calculating event loop load as an exponential moving average of period loop utilization, rapid changes in utilization are smoothed into short, medium and long-term trend data. The event loop load, similarly, is expressed as a value from zero to one. The event loop load metric may be used in the same manner as the loop iteration utilization metric but may yield results more representative of application capacity and utilization trends for long running event loop-based applications.

The loop iteration utilization and event loop load metrics may be consumed per-event loop, aggregated across multiple event loops within a single process or aggregated over part or all of an application cluster comprising one or more processes executing on one or more computing devices. At the event loop level, the loop iteration utilization and event loop load metrics may indicate resource utilization in relation to a current input/output load being experienced by the computing resources (for example, the number of concurrent clients interacting with a computing system) allocated to that event loop. As aggregate metrics, the loop iteration utilization metric and the event loop load metric may indicate an overall process (where a process consists of multiple event loops) or application cluster resource utilization or provide high-level indicators of application health. The loop iteration utilization metric or the event loop load metric may serve as a frontline indicator for triggering, for example, scaling of computing resources, allocation of application processes to new incoming input/output load according to current resource utilization, or tuning application code to better manage current load with available computing resources.

The loop iteration utilization and the event loop load metrics include numerous uses, including application as metrics for triggering auto-scaling events. In an example, the event loop load indicates that an application cluster should scale up or down to meet demand. The event loop load may provide scaling with greater fidelity than CPU usage, which is classically used to trigger such scaling events. Further, when used in conjunction with CPU usage, loop iteration utilization or event loop load may indicate whether an event loop has reached its resource limit due to application code or due to the resources allocated to the event loop. For example, when running a process within a container that has been allocated a single CPU, performing work off the main event loop thread will cause the process to reach its CPU resource limit before the event loop begins to reach its maximum capacity to process additional events. Additionally, loop iteration utilization or event loop load may provide a useful indication of overall event loop health that may be more valuable than other lower-level metrics at surfacing first-level concerns about overall performance of an application and/or an individual process.

In an embodiment, computing resources may be scaled up or down based on the event loop load metric. In an embodiment, by scaling an application cluster using the event loop load metric rather than a generic metric such as CPU usage, the responsiveness of the application may be improved by ensuring that enough resources are always available to handle additional event processing (e.g. incoming network traffic), and/or save cost be ensuring that resources do not remain idle. Various metrics understood in the art have failure modes or weaknesses that the loop iteration utilization metric and the event loop load metric do not suffer from. For example, a process performing a series of cryptographic operations may perform work off a main event loop thread, and in this case, process CPU usage may go well above the scaling limit even where the main event loop thread is not near the limit of how many events can be processed.

In an embodiment, the event loop load metric is a value from zero to one. A value of one indicates the event loop is used at maximum capacity. When event loop load is applied to application cluster auto-scaling, a user may define an acceptable range to trigger scaling events. In an embodiment, event loop load deals directly with the ability of an application to execute code and process events and is able to disregard other factors that may artificially inflate or understate metrics (such as CPU). This enables event loop load to provide a more accurate scaling trigger that connects more directly to application execution and the ability to handle current load.

In an embodiment, an auto-scaling trigger range may normally be informed by the needs of a user and the user's expectation of constancy in traffic. For example, an application expecting to receive traffic with bursts of activity may need to over-provision to be optimally reactive to changes in load. Further for example, an application expecting a relatively constant load with slower variations may set a tighter range to experience cost benefits of provisioning closer to the actual ability to handle the load. Event loop load may be utilized to drive decisions with greater precision regarding the tradeoff between responsiveness and the cost of maintaining a cluster of processes. For example, where the priority is to minimize the 99^{th} percentile response latency for all users for a more consistent user experience, capacity overhead may be built into the acceptable event loop load value range that triggers scaling events. For example, in a more cost-sensitive situation where occasional higher-latency responses are acceptable, a cluster may be scaled within a tighter relation to overall capacity such that the correct amount of processing resources (e.g. hardware, containers, or other cost unit) is utilized without unnecessary excess.

As used herein, “capacity” may refer to the number of units of work or tasks that an application, such as a Node.js application, can support at peak performance. Commonly, capacity is evidenced through a metric such as requests per second. Such metrics show there is a ceiling that, once reached, cannot be breached. Beyond this ceiling, typical application behavior, such as Node.js application behavior, is to reduce performance as the process is stressed beyond its ability to handle the given load. Maximum capacity may be different for various workloads within different environments. There currently exists no suitable method known in the art for predicting the capacity of an event loop based application other than exercising it through load and observing its ability to serve that load. The primary limiting factor of capacity is often the amount of CPU resource available to a process. Additional factors include network, file system, and other inputs/outputs that place their own caps on the overall capacity. In many instances, the limiting factor is CPU, however, regardless of limiting factor, the number of events a process (such as a Node.js process) can execute does not scale linearly in practice. Typical workloads involve interaction with external resources that have their own scaling behavior and capacity constraints that will in turn exert impact. Because CPU is the typical limiting factor, it is commonly used as the measure of capacity and hence the trigger for many auto-scaling mechanisms. The loop iteration utilization metric disclosed herein represents a proportional measure of the amount of work an event loop is performing in relation to its maximum capacity. As such, loop iteration utilization is a more accurate measure of how close a process and/or cluster of processes is to reaching its capacity ceiling than CPU or other metrics known in the art. Further, event loop load, as a timeseries and exponential moving average representation of loop iteration utilization, provides a practical tool for application of loop iteration utilization to uses such as auto-scaling, evenly distributed load-balancing or application performance health indication.

In an embodiment, the loop iteration utilization and event loop load metrics are determined in part based on a loop duration. In an embodiment, the loop duration is the length of time it takes to execute a single loop iteration. In an embodiment, the loop iteration is a single execution of an event loop starting from or before a first event provider request and ending at or before a subsequent event provider request. In an embodiment, the loop duration metric is calculated by recording and comparing timestamps between a timestamp taken at the beginning of a first loop iteration and a timestamp taken at the beginning of a subsequent loop iteration. In an embodiment, the event provider request is a request made by the event loop to an event provider to pause execution of the event loop and wait for arrival of the event. In an embodiment, the event provider is a mechanism used to pause execution of the event loop and wait for arrival of the event. In an embodiment, the event provider passes the received event to an event handler which may in turn trigger zero or more callbacks within the application code for processing. In an embodiment, the event is an entity that encapsulates an asynchronous action and contextual variable originating from the operation request from the application code. In an embodiment, the callback is executable code that processes the event within the application code and may be triggered by the event handler from within the event loop.

As used herein, “event loop” may refer to a programming construct that pauses execution when waiting for arrival or retrieval of an event for processing. The event loop may alternatively be referred to as a message dispatcher, a message loop, a message pump, a run loop, a main loop, or a main event loop. The event loop makes a request to an internal or external event provider and then calls the relevant event handler that is configured to dispatch the event. The event loop is in contrast with a traditional command-line-driven alternative where a program is run one time and then terminated. The event loop is further in contrast with a menu-driven design that may still feature a main loop but presents an ever-narrowing set of options until the appropriate task is the only option available.

As used herein, an “event” may refer to an entity that encapsulates an asynchronous action and a contextual variable trigger of the action when received by the event loop.

As used herein, “event provider” may refer to a mechanism for pausing execution of the event loop to wait for arrival of an event. The event provider may be passed a timeout at a time of an event provider request and the timeout may last a maximum duration of time the event provider waits before returning. The event provider may refer to the component of the event loop responsible for pausing execution of the event loop and waiting for arrival of the event from asynchronous event generation mechanisms, such as incoming network requests, filesystem data reads, CPU interrupts and other such mechanisms. The event provider may implement a utility such as “poll”, “kqueue”, “select” or message passing mechanisms as provided by dependent utilities or operating systems.

As used herein “poll” may refer to monitoring and retrieving file descriptors for an input/output event. In various embodiments a poll may also be referred to as an action of the event provider, i.e. an event receiver mechanism utilized by an event loop to block a program until a request returns an event. In an embodiment, loop idle time (alternatively referred to as wait time or poll wait) may include a time where no event is available, and the thread idles until an event is received. In an embodiment, implementations of an event receiver mechanism, or poll, may support a timeout, or duration of time before returning regardless of whether events have been received or not. In an embodiment, events waiting indicates the number of events available immediately at the time the event receiver mechanism is invoked. In an embodiment, events processed indicates the total number of events processed during a single iteration of the event loop as a result of being returned by the event provider.

In an embodiment, the loop iteration utilization metric and the event loop load metric are determined in part based on a loop idle time. In an embodiment, the loop idle time is a length of time the event provider spends idly waiting for arrival of an event. In an embodiment, the loop idle time refers only to the time spent idling in the event provider when there are no available events to process. In an embodiment where there are one or more events waiting, the time spent in the event provider is utilized to retrieve the list of available events and the event loop is not actually idle. Further, time spent retrieving the event list may not be included in the loop idle time regardless of whether the event provider idled. In an embodiment where the number of events retrieved after the event provider has idled is typically close to one, the amount of time spent waiting may be short enough that it does not have a noticeable impact on aggregated metrics.

In an embodiment, the loop iteration utilization metric and the event loop load metric are determined in part based on a loop processing time metric. The loop processing time may be determined based on subtracting loop idle time from loop duration. The loop processing time may be similar to CPU but has several differences from the CPU usage. In an embodiment, the loop processing time includes all loop time, idle or not, not waiting for arrival of new events in the event provider. In an embodiment, loop processing time does not include work done off an event loop thread, for computationally expensive cryptographic work performed asynchronously in Node.js.

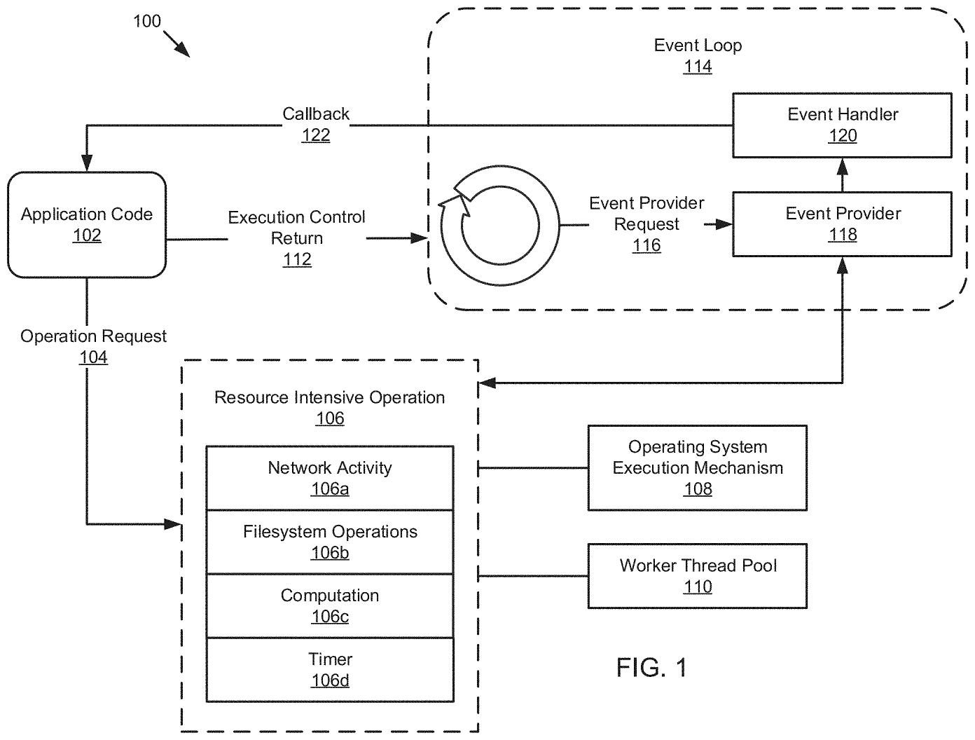

Referring now to the figures, FIG. 1 illustrates a block diagram of a system 100 for processing requests through an event loop. The system 100 may be implemented in various implementations and environments, including for example Node.js. In the system 100, application code 102 may cause an operation request 104 for a resource intensive operation 106 to be executed in an asynchronous manner. Example operations of the resource intensive operation 106 may include, for example, network activity 106a, filesystem operations 106b, computation 106c such as CPU-intensive computation, or timers 106d. Such resource intensive operations 106 may be executed by means of an operating system execution mechanism 108 (such as asynchronous network requests), worker thread pool 110, or other means of asynchronous execution. Once the application code 102 has finished its current block of synchronous execution, it returns application execution control 112 to the event loop 114. The event loop 114 periodically executes an event provider request 116 to an event provider 118 to receive the status of ongoing operations. The event provider 118 implements an event receiver operation appropriate for the system and/or operation types being executed (e.g. “poll”, “select”, “kqueue”, etc.) and can retrieve events or alternatively wait for a specified timeout period, blocking the event loop 114 while waiting for additional events. Once available, one or more events are returned to the event loop 114 to an event handler 120 which is responsible for event filtering, adjustment and/or passing events to application code via a user-supplied callback 122 within the application code 102. Execution control is passed to the application code 102 by means of such a callback 122, where control remains and may trigger additional operation requests 104 before returning execution control 112 back to the event loop 114 for additional cycles of this process.

In an embodiment, a plurality of process threads is utilized. The event loop 114 executes within one such thread, which may alternatively be referred to as the main loop, main event loop, main thread, or event thread. The event loop 114 causes application code 102 to execute within the same thread (which may in turn utilize additional threads for its own purposes). Some operations are executed via a non-blocking or asynchronous mechanisms via the operating system execution mechanism 108 which are outside the control of the event loop 114. Other operations execute within a worker thread pool 110 which contains one or more of another type of thread and may alternatively be referred to as the thread pool or worker pool. While a thread is executing an operation (e.g. the main thread executing application code, or a worker thread executing an intensive task), the thread is said to be blocked. While a thread is blocked, it is not able to handle work created by additional operation requests 104. While the main thread is blocked, the event loop 114 is unable to receive and handle additional requests. This provides motivations (e.g. performance and security) for minimizing thread blocking in both the main thread and the worker thread pool.

Certain intensive operations are executed via means of a worker thread pool 110, while others are delegated to the operating system (e.g. Linux™, OSX™, Solaris™, or Windows™) via an operating system execution mechanism. Such a mechanism is typically (but not exclusively) exposed in the form of file descriptors that are used to interact with input/output components of a system. The event provider 118 uses an operating system specific mechanism, such as “poll” to inspect these file descriptors whereby the operating system is asked for the status of certain file descriptors. Activity in a file descriptor, e.g. network activity being triggered by an external client, causes the operating system to create an event which is passed via the event provider 118 through to the event loop 114 to the event handler 120 and may additionally be passed out of the event loop 114 to application code 102 via a callback 122. Operations executed within the worker thread pool 110 may also be encapsulated in events that are similar to operating system events. All events are provided to the event loop 114 for handling. Such handling generally involves eventually triggering a callback 122 into the application code 102 where the event is passed for handling according to the instructions provided by the application programmer.

In an embodiment, the event loop 114 maintains a first-in-first-out (FIFO) event queue such that every new event is placed at the back of a line and waits its turn to be handled by the event handler 120 (and potentially application code 102 via a callback 122). The event loop 114 may alternatively be referred to as a message dispatcher, message loop message pump, and/or run loop. The event loop 114 may form the central control flow construct of a program and may constitute the highest level of control within the program. The event loop 114 may be utilized as a method for implementing inter-process communication and may be a specific implementation technique for message passing.

The event includes an action or occurrence recognized by software and it may originate asynchronously from an external environment. Events may be generated and/or triggered by a thread other than the main thread via the worker thread pool 110 or the operating system execution mechanism 108, or may originate from an external input/output device, an internal input/output device, a system timer, a system interrupt, a user, a network operation and so forth. Events may be handled synchronously with program flow such that software may have one or more dedicated places where events are handled. Such places are triggered in application code 102 via callbacks 122 but may extend to many other places within an application according to the programmed logic. A source of the event may include a user interacting with software by way of, for example, keystrokes on a keyboard. A source of the event may be a hardware device such as a network interface. A source of the event may be an internal system construct such as a timer interrupt. Additionally, software may trigger one or more events into the event loop 114, e.g. to communicate the completion of a task, and so forth.

Events may be eventually handled in application code by callbacks 122. Each event may be a piece of application-level information from an underlying framework such as a graphical user interface (GUI) toolkit. Such GUI events may include, for example, key presses, mouse movement, action selections, timers expiring, and so forth. Additionally, an event may represent availability of new data for reading a file or network stream.

An event provider 118, which may make use of a poll-type operation in some circumstances. Such a poll operation is a means by which the event loop may request events from a system. Such poll operations may be used to block the main thread until an event is available, or until a predetermined timeout occurs. In an embodiment, the event provider 118, is given a timeout equal to a maximum duration of time to wait before returning, regardless of whether an event is available or not. The event provider 118 may return zero to many events in response to a single event provider request 116. The use of a timeout is a means by which an event loop 114 does not expend unnecessary time querying for events where none exist, thereby expending unnecessary resources. An event-driven application (primarily embodied in the application code 102), making use of an event loop 114 application does not require execution unless events exist to be processed. Where no events exist to be processed, a timeout is an appropriate mechanism to pause (or block) a thread.

In a Unix implementation, the “everything is a file” paradigm may lead to a file-based (or file-descriptor based) event loop 114. Reading from (often “polling”) and writing to files, inter-process communication, network communication, and device control may be achieved using file input/output with the target identified by a file descriptor via a “select” operation. The select and poll system may allow a set of file descriptors to be monitored for a change of state, e.g. when data becomes available to read.

In a Microsoft Windows™ implementation, a process that interacts with a user must accept and react to incoming messages, and this may be performed by a message loop in that process. The message may be equated to an event created and imposed upon the operating system. The event may include, for example, user interaction, network traffic, system processing, timer activity, inter-process communication, and so forth. Further, for non-interactive, input/output only events, the Microsoft Windows™ implementation may have input/output completion ports. The input/output completion port loops may run separately from a message loop and do not interact with the message loop out of the box.

Both Unix and Microsoft Windows™ implementations may be abstracted to a general form whereby interaction via application code 102 does not required specific understanding of the underlying operating system, but instead relies on abstracted operation requests 104 to make requests of the operating system and the event provider 118 having operating system specific implementations able to query and encapsulate events as they are made available to the application.

In an embodiment, the loop iteration utilization is calculated based on two of three possible components, namely loop processing time, loop duration, and loop idle time. In various implementations, the loop iteration utilization is calculated by any of Equation 1, Equation 2, or Equation 3, below.

$$\begin{matrix}loop iteration utilization = \frac{loop processing time}{loop duration} & Equation 1 \\ loop iteration utilization = 1 - ( \frac{loop idle time}{loop duration} ) & Equation 2 \\ loop iteration utilization = \frac{loop processing time}{loop idle time + loop processing time} & Equation 3\end{matrix}$$

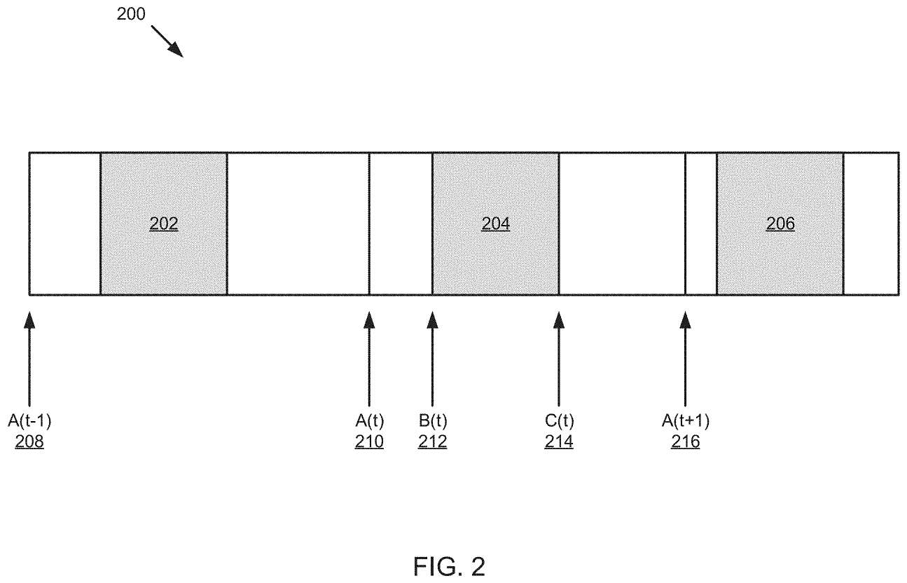

FIG. 2 illustrates a block diagram of an event loop 200 including markers for determining loop processing time as non-timeseries data. The event loop 200 includes a first event provider request 202, a second event provider request 204, and a third event provider request 206. As illustrated in FIG. 2, all points, including Aₜ₋₁ 208, Aₜ 210, Bₜ 212, Cₜ 214, and Aₜ₊₁ 216 refer to timestamps for determining various metrics based on the event loop 200.

In an embodiment, point Bₜ 212 indicates entry into the second event provider request 204 (i.e. a request to the event provider for a list of available events) and may occur after or at the same time as the beginning of a determined loop duration at point at Aₜ 210. Further, point Cₜ 214 indicates the exit from the second event provider request 204 or return of the event provider 118 and may occur immediately after, or sometime after entry into the second event provider request 204 at point Bₜ 212. In an embodiment as illustrated in FIG. 2, the timestamp that determines the end of the loop at point Aₜ₊₁ 216 occurs after the return of the event provider 118 at point Cₜ 214.

A loop duration is a duration of time occupied by the event provider 118, (i.e. a duration of time an event provider 118 runs as a result of an event provider request 116) and the event handler 120, which may include execution of application code 102 invoked by the event handler 120 via callbacks 122. In an embodiment, the loop duration is defined by Aₜ₋₁−Aₜ (see 208 and 210).

A wait time (may also be referred to as an event provider wait time or a poll time) is a duration of time occupied by the event provider 118 (i.e., a duration of time an event provider 118 runs required as a result of an event provider request 118). In an embodiment, the wait time is defined by Cₜ−Bₜ (see 214 and 212).

Loop processing time is a duration of time not spent in the loop idle time during the loop duration. In an embodiment, the processing time is defined by [loop duration—idle time] and may include time spent in the event handler 120 and application code 102.

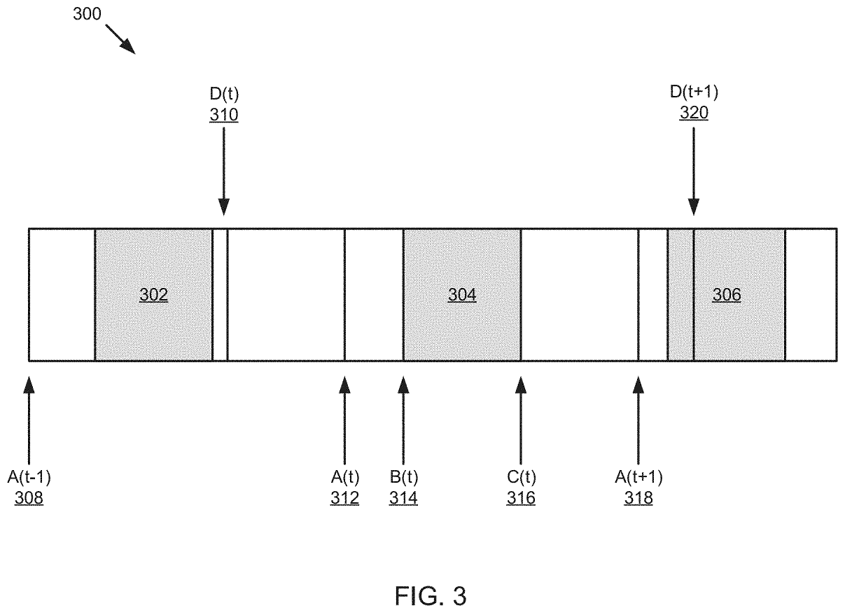

FIG. 3 illustrates a block diagram of an event loop 300 including markers for determining loop iteration utilization as timeseries data. The loop iteration utilization determined as timeseries data may be referred to as period loop utilization. In an embodiment, the period loop utilization may be entered into an exponential moving average to generate an event loop load metric. As illustrated in FIG. 3, all points, including Aₜ₋₁ 308, Dₜ 310, Aₜ 312, Bₜ 314, Cₜ 316, A₍ₜ₊₁₎ 318, and D₍ₜ₊₁₎ 320 refer to timestamps for determining various metrics based on the event loop 300. The event loop 300 includes a first event provider request 302, a second event provider request 304, and a third event provider request 306 as illustrated.

A load collection period (may also be referred to as the event load average time interval, or load interval) is a period of time used to convert non-timeseries processing time data into timeseries data for the calculation of a period loop utilization metric, and further an event loop load as an exponential moving average of period loop utilization. In an embodiment, the load collection period is defined by D₍ₜ₊₁₎−Dₜ (see 320 and 310). In such an embodiment, any given point Dₜ 310 can occur at any point within the event loop 300.

The period processing time is the aggregate loop processing time during the load collection interval used to calculate timeseries data. In an embodiment, the period processing time is the sum of all loop processing time between Dₜ 310 and D₍ₜ₊₁₎ 320. Period processing time may also include adjustments required to account for Dₜ 310 and/or Dₜ₊₁ 320 existing within a block of loop processing time.

The period loop utilization is a ratio of the period processing time and the load collection period used to calculate the timeseries data. The event loop load may be stored as an exponential moving average of period loop utilization for additional utility to the end-user or consumption mechanism.

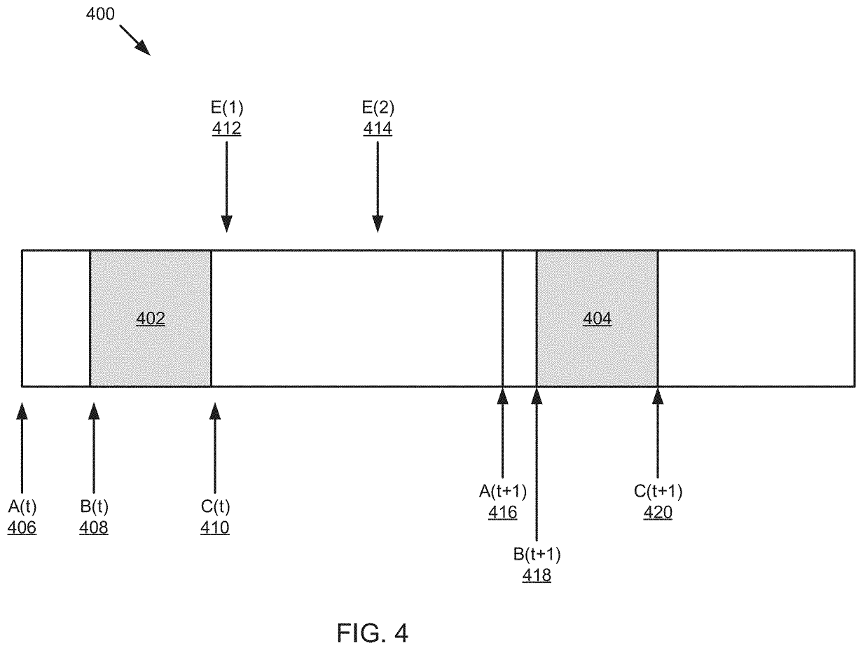

FIG. 4 illustrates a block diagram of an event loop 400 including markers for determining loop iteration utilization as non-timeseries data. As illustrated in FIG. 4, each of points Aₜ 406, Bₜ 408, Cₜ 410, E₁ 412, E₂ 412, A₍ₜ₊₁₎ 416, B₍ₜ₊₁₎ 418, and C₍ₜ₊₁₎ 420 are timestamps. Points E₁ 412 and E₂ 414 refer to timestamps where an event has accumulated and is ready to be retrieved. The event loop 400 includes a first event provider 118 execution 402 triggered by an event provider request 116 at Bₜ 408, and a second event provider 118 execution 404, triggered by an event provider request 116 at Cₜ 410 as illustrated.

In an embodiment, the events waiting is the number of events that have accumulated during the loop processing time of the event loop 400. Events occurring during loop processing time may be held in a queue by the underlying asynchronous execution mechanism and wait for the next event provider 118 execution to be immediately dispatched via the event handler 120. In an instance as illustrated in FIG. 4, no idle time occurred, and the wait time is not included in the loop idle time for the event loop 400. As illustrated in FIG. 4, events E₁ 412 and E₂ 414 are available during the processing time between Cₜ 410 and A₍ₜ₊₁₎ 416. Thus, when the event provider 118 was entered at B₍ₜ₊₁₎ 418, the events E₁ 412 and E₂ 414 were immediately available for retrieval by the event handler 120. Therefore, the event provider 118 may immediately return at C₍ₜ₊₁₎ 420 and the events waiting count will be equal to two. Because the events waiting count is greater than zero, the wait time for C₍ₜ₊₁₎−B₍ₜ₊₁₎ (see 420 and 418) zero and is therefore not included in loop idle time.

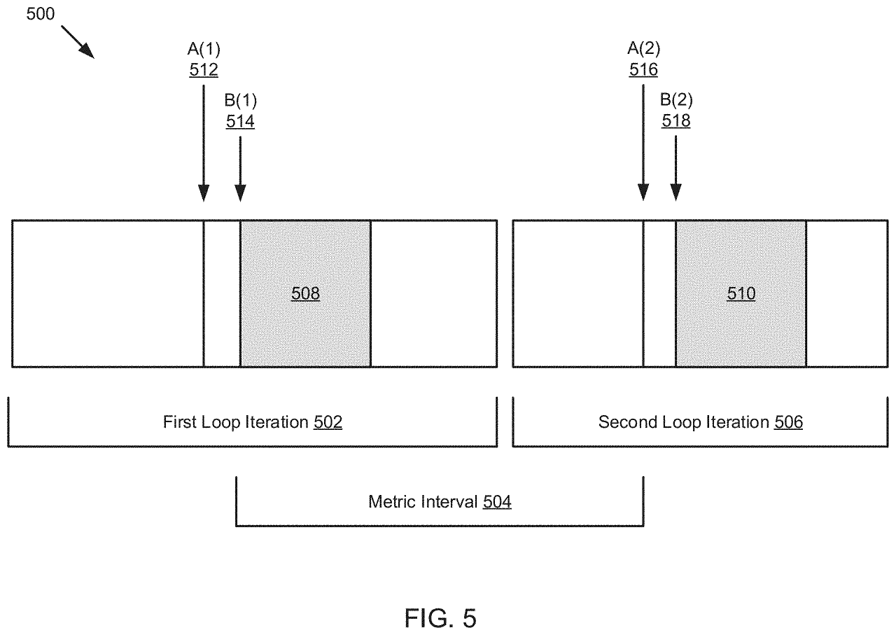

FIG. 5 is a block diagram of an event loop 500. The event loop 500 includes a first loop iteration 502, a second loop iteration 506, and a metric interval 504. Each of the first loop iteration 502 and the second loop iteration 506 is a single iteration of the event loop beginning with an event provider request and ending subsequent to completion of the event provider request. In an embodiment as illustrated in FIG. 5, the metric interval 504 is a duration of time between execution of two subsequent metrics callbacks at B₁ 514 and A₂ 516 as illustrated in FIG. 5. In FIG. 5, points A₁ 512 and A₂ 516 indicate timestamps where metrics callbacks are called. Points B₁ 514 and B₂ 518 indicate where the event provider 118 is entered as a result of an event provider request 116, (alternatively referred to as the entering of the poll phase), namely the first event provider 508 and the second event provider 510, respectively. The metric interval 504 roughly corresponds to a duration of time it takes for an iteration (or “turn”) of the event loop 114 (which also includes execution of application code 102), for example the duration of time for the first loop iteration 502 and/or the second loop iteration 506. The metric interval 504 may be generated by recording and comparing timestamps between calls of the metrics callback.

A metrics callback is a call by an instrumented event loop into the metrics calculation subsystem. Such a callback is triggered by the event loop at a predetermined point in the event loop such that accuracy is maximized and impact on event loop performance is minimized.

The loop iteration utilization metric may be calculated with greater accuracy when the metric interval 504 is pinned to an event provider request 116 of the event loop 114. In doing this, the amount of work performed as a result of input/output operations taking place during a single loop may be accounted for. Such work may bleed over into a next loop before the next event provider request 116. As illustrated in FIG. 5, the metrics reported to the metrics callback includes data from two different event loops, namely the first loop iteration 502 and the second loop iteration 506 but encapsulates a single input/output interval.

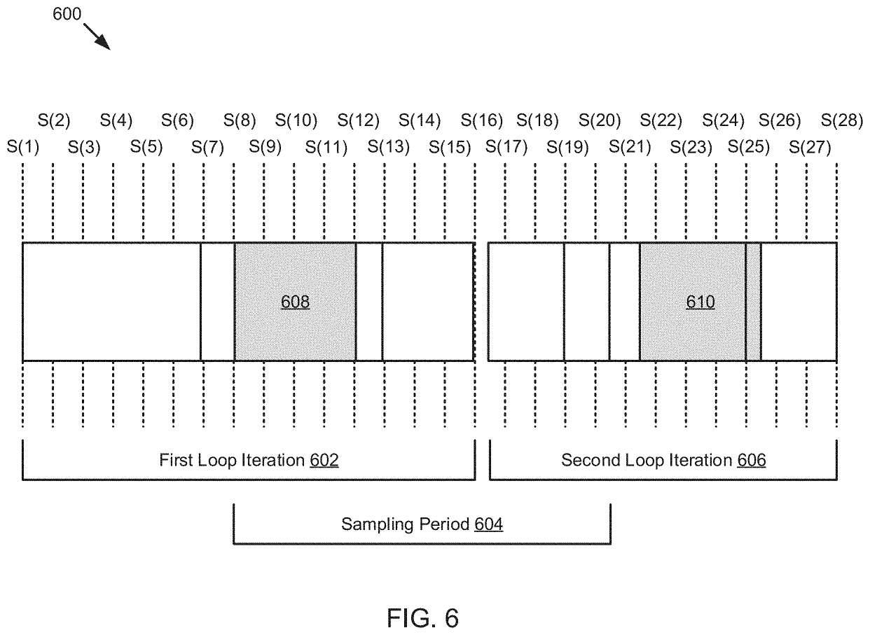

FIG. 6 depicts a schematic diagram of a process 600 of determining metrics for an event loop by sampling. Sampling may further be referred to as performance counters or performance sampling. The example process 600 as illustrated in FIG. 6 includes the first loop iteration 602 and the second loop iteration 606. The first loop iteration 602 undergoes a first event provider 608 and the second loop iteration 606 undergoes a second event provider 610. A series of samples are taken, namely S(1), S(2), S(3), S(4), S(5), S(6), S(7), S(8), S(9), S(10), and so forth up to S(28) as illustrated in FIG. 6. It should be appreciated that sampling may occur at any suitable time interval and may occur indefinitely or for a determined total period. Event loop metrics may be determined based on data gathered by samples taken during a sampling period 604.

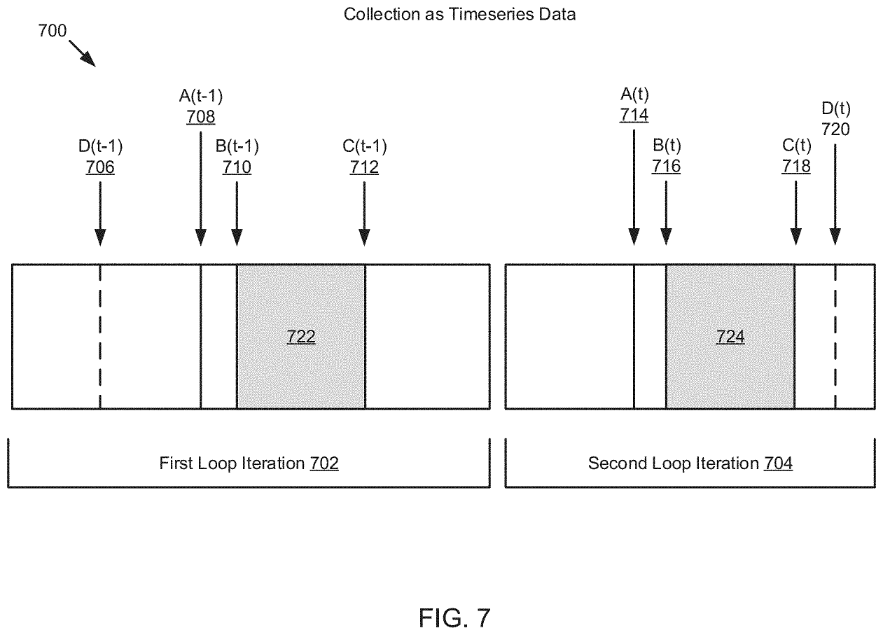

The event loop is inspected at regular intervals, i.e. the samples S(1)-S(28). The state of the event loop is recorded and tracked at each sample S(1)-S(28). The state of the event loop may be either “processing” or “idle.” The event loop may be inspected over the sampling period 604 to determine aggregate metrics for the event loop. The sampling period 604 may also be referred to as a period duration, like the period duration discussed with respect to timeseries data as illustrated in FIG. 7.

The duration of the sampling period 604 may vary significantly in varying implementations of the process 600. The sampling period 604 may span an arbitrary number of iterations of the event loop, from a single iteration that does not complete during the sampling period 604, to many short iterations of the event loop, to a long duration of time including many complete iterations of the event loop, and so forth. The sampling period 604 may be a regular cycle of samples that are taken on the event loop. The sampling period 604 may be triggered to repeat at specific times, to sample a specified number of times, and/or to sample the event loop for a predetermined total duration of time. Each sample S(1)-S(28) may be taken at a regular interval, for example every one second, every three seconds, every one minute, and so forth. As illustrated in FIG. 6, the sampling period 604 may occur at any time and need not be drawn to any occurrence within the event loop, such as a start or end of the event loop or a start or end of the event provider.

The accuracy of the process 600 may increase if the sampling period 604 occurs over a longer duration and samples S(1)-S(28) the event loop more frequently. The process 600 provides an estimate of the time the event loop spends in a processing state or an idling state. The accuracy of this estimate may increase as the frequency of the sampling S(1)-S(28) is made more frequent and/or as the duration of the sampling period 604 is extended.

The process 600 of sampling may be very efficient in an implementation where a lot of activity is occurring and the state of the event loop changes frequently. In such an implementation, sampling may be more efficient than tracking variables because the frequent state changes for the event loop generates a significant amount of data to store over time.

In an embodiment, the event loop is sampled over the sampling period 604. The sampling period includes a predefined number of samples S(1)-S(28) that were taken at defined time intervals, for example every two seconds for the duration of the sampling period 604. Each sample S(1)-S(28) indicates whether the event loop was in a processing state or an idling state at that time. The samples S(1)-S(28) taken over the duration of the sampling period 604 are aggregated to determine an estimate of the sampling period idling time and the sampling period processing time for the event loop. After a sufficient number of iterations of a plurality of sampling periods, the estimate of a period idle time and a period processing time may be determined for the event loop. The period duration may refer to the duration of time of the sampling period 604. The period duration, the period idle time, and the period processing time may be utilized to determine further metrics for the event loop such as the period loop utilization and the event loop load.

The total samples refers to the number of samples taken during the sampling period 604. The total samples includes the total number of idle samples and the total number of processing samples. The total samples may be a time-based calculation, e.g. duration of time samples were taken multiplied by the number of samples taken in a predefined time interval.

In a sampling embodiment as illustrated in FIG. 6, the period loop utilization for the event loop may be calculated based on either of Equation 4 or Equation 5, below.

$$\begin{matrix}period loop utilization = \frac{number of processing samples}{total samples} & Equation 4 \\ period loop utilization = 1 - \frac{number of idles samples}{total samples} & Equation 5\end{matrix}$$

Sampling may be carried out in either of a top-down or bottom-up embodiment. In a top-down embodiment, an internal agent may run on a separate thread and sample the state of the event loop. The sampling may occur at predefined intervals or may occur in response to a trigger event. In such an embodiment, the event loop may have a state indication (may be referred to as a “flag”) that is altered when the event loop transitions between a processing state and an idling state. The internal agent may inspect the state indication each time it samples the event loop to determine whether the event loop is in a processing state or an idling state at that sampling time.

In a bottom-up embodiment, an external agent may inspect a process to examine a state of the process. A tool may inspect the state of a running program to look for signs and determine whether an event loop is in a processing state or an idle state. The tool may look at system calls and current code stack to make such a determination. The sampling metrics determined by the external agent may be used to determine period loop utilization and further the event loop load without using internal instrumentation.

FIG. 7 depicts a schematic diagram of a process 700 for determining metrics for an event loop captured as timeseries data. The process 700 include a first loop iteration 702 and a second loop iteration 704. The first loop iteration 702 includes a first event provider 722 and the second loop iteration 704 includes a second event provider 724. A first metrics callback Dₜ₋₁ 706 is called during the first loop iteration 702 and a second metrics callback Dₜ 720 is called during the second loop iteration 704. At Aₜ₋₁ 708 and at Aₜ 714 a callback is generated to notify a user or program that the system is about to enter the event provider. At Bₜ₋₁ 710 and at Bₜ 716 the system enters the event provider. At Cₜ₋₁ 712 and at Cₜ 718 the system exits the event provider.

Metrics collection may occur at any suitable time intervals. For example, metrics collection may occur from [Aₜ, Bₜ], [Bₜ, Cₜ], [Cₜ, Dₜ]. A loop idle time may be determined as a duration of time the event provider spends idly waiting for arrival of an event. A period idle time may be determined as an aggregate of the loop idle time during a load collection period. The period idle time may particularly refer to the idle time as calculated as timeseries data. The period idle time may be dependent on whether there are any events available to retrieve or receive when the event provider is entered.

A period duration is a duration of time used to aggregate the loop idle time across all event provider requests within a period duration. In the embodiment illustrated in FIG. 7, the period duration extends between the first timestamp at Dₜ₋₁ 706 and the second timestamp at Dₜ 720. The period duration may be particularly applicable to determinations made based on timeseries data, wherein the period duration is a duration of time between a first timestamp and a second timestamp. The timestamps for determining the period duration may occur at predetermined intervals but need not be tied to a specific occurrence such as, for example, entering or exiting the event provider. The first timestamp and the second timestamp in a timeseries implementation may be arbitrarily determined.

In an embodiment, a period processing time is equal to the period duration (i.e. the period duration between the first timestamp and the second timestamp that is utilized for determining the period duration) minus the period idle time. The period processing time may be calculated as an aggregate of loop processing time within a period duration, and/or the period idle time may be calculated as an aggregate of loop idle time within the period duration. In an embodiment, a period loop utilization is equal to the period processing time divided by the period duration. An event loop load is an exponential moving average for tracking period loop utilization over time.

In an embodiment, an end-goal metric is the event loop load. The event loop load may be utilized to scale processing capacity up or down based on the event loop load by adding or removing one or more processes. The event loop load may further be used to distribute load based on the event loop load by directing one or more events to one or more other event loops or to one or more other processes. In a timeseries embodiment, the event loop load is an exponential moving average timeseries representation of the loop iteration utilization that focuses on blocks of times (may be referred to as “periods”) rather than an individual iteration of the event loop.

In an embodiment, an intermediate metric to be calculated is the period loop utilization. In a timeseries implementation, the period loop utilization is a timeseries representation of loop iteration utilization. The period loop utilization focuses on blocks of times (“periods”) rather than individual iterations of the event loop. Such values for determining the period loop utilization are calculated by an instrumented event loop where time periods can be recorded and stored for later reference.

The period loop utilization may be determined based on two of the following three metrics: period duration, period idle time, or period processing time. Each of the period loop utilization, the period duration, the period idle time, and the period processing time may refer to timeseries-based metrics. The period loop utilization may be calculated by any of the three following equations, namely Equation 6, Equation 7, and Equation 8, below.

$$\begin{matrix}period loop utilization = \frac{period processing time}{period duration} & Equation 6 \\ period loop utilization = 1 - \frac{period idle time}{period duration} & Equation 7 \\ period loop utilization = \frac{period processing time}{period processing time + period idle time} & Equation 8\end{matrix}$$

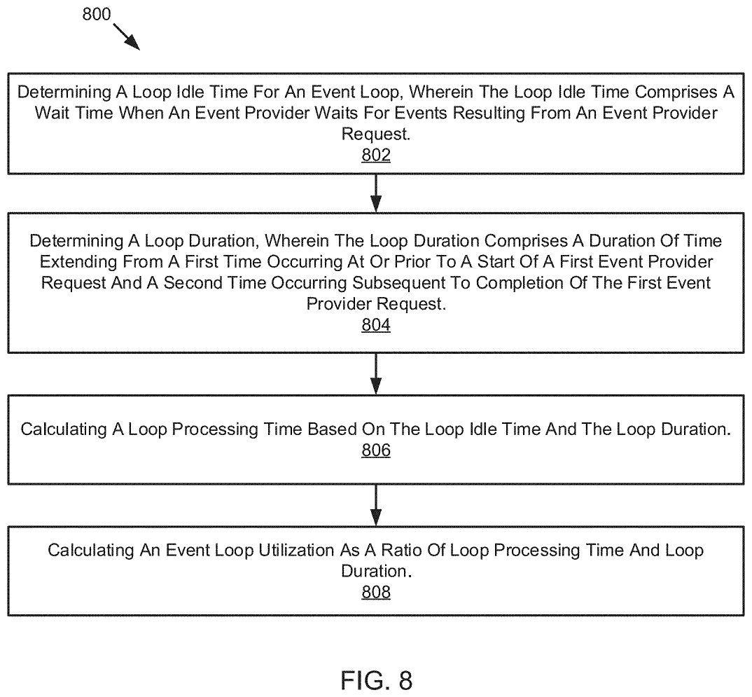

FIG. 8 illustrates a schematic flow chart diagram of a method 800 for determining loop iteration utilization in non-timeseries form for an event loop 114. The method 800 may be performed by any suitable computing device. Such computing device may be in communication with an event loop 114 and/or may receive metrics determined based on activity of the event loop 114.

The method 800 begins and the computing device determines at 802 a loop idle time for an event loop, wherein the loop idle time comprises a wait time when the event provider 118 waits for events, resulting from an event provider request 116. The method 800 continues and the computing device determines at 804 a loop duration, wherein the loop duration comprises a duration of time extending from: a first time occurring at or prior to a start of a first event provider request 116 and a second time occurring subsequent to completion of the first event provider request 116. The method 800 continues and the computing device calculates at 806 a loop processing time based on the loop idle time and the loop duration. The method 800 includes at and the computing device calculates at 808 an event loop utilization as a ratio of loop processing time and loop duration.

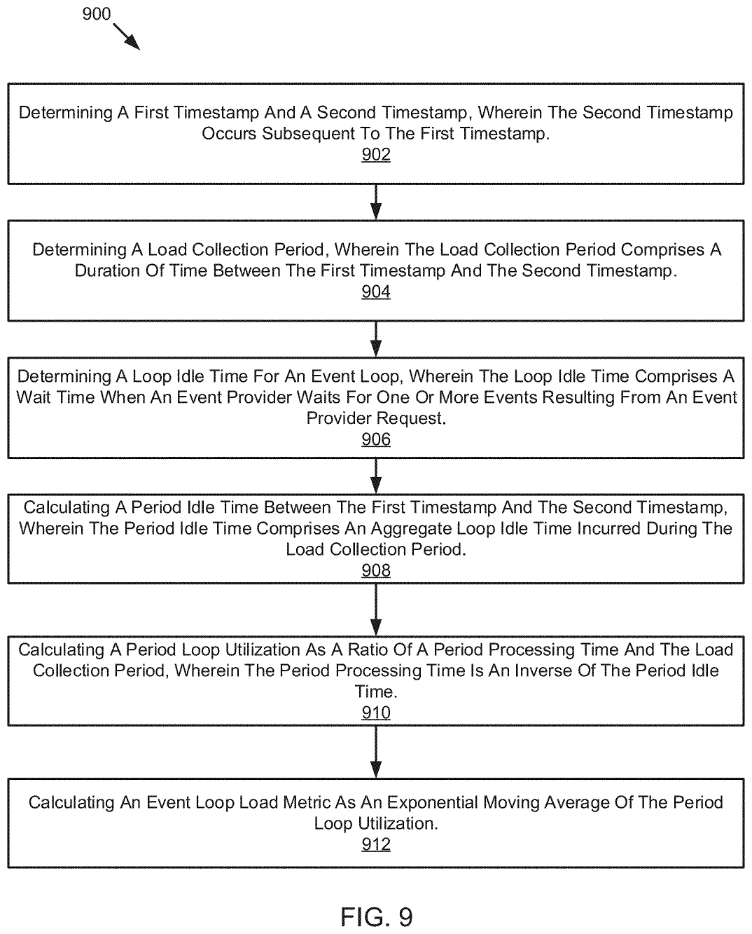

FIG. 9 is a schematic flow chart diagram of a method 900 for determining an event loop load for an event loop 114. The method 900 may be performed by any suitable computing device. Such computing device may be in communication with an event loop 114 and/or may receive metrics determined based on activity of the event loop 114.

The method 900 begins and the computing device determines at 902 a first timestamp and a second timestamp, wherein the second timestamp occurs subsequent to the first timestamp. The method 900 includes determining at 904 a load collection period, wherein the load collection period comprises a duration of time between the first timestamp and the second timestamp. The method 900 includes determining at 906 a loop idle time for an event loop, wherein the loop idle time comprises a wait time when an event provider waits for one or more events resulting from an event provider request. The method 900 includes calculating at 908 a period idle time between the first timestamp and the second timestamp, wherein the period idle time comprises an aggregate loop idle time incurred during the load collection period. The method 900 includes calculating at 910 a period loop utilization as a ratio of a period processing time and the load collection period, wherein the period processing time is an inverse of the period idle time. The method 900 includes calculating at 912 an event loop load metric as an exponential moving average of the period loop utilization.

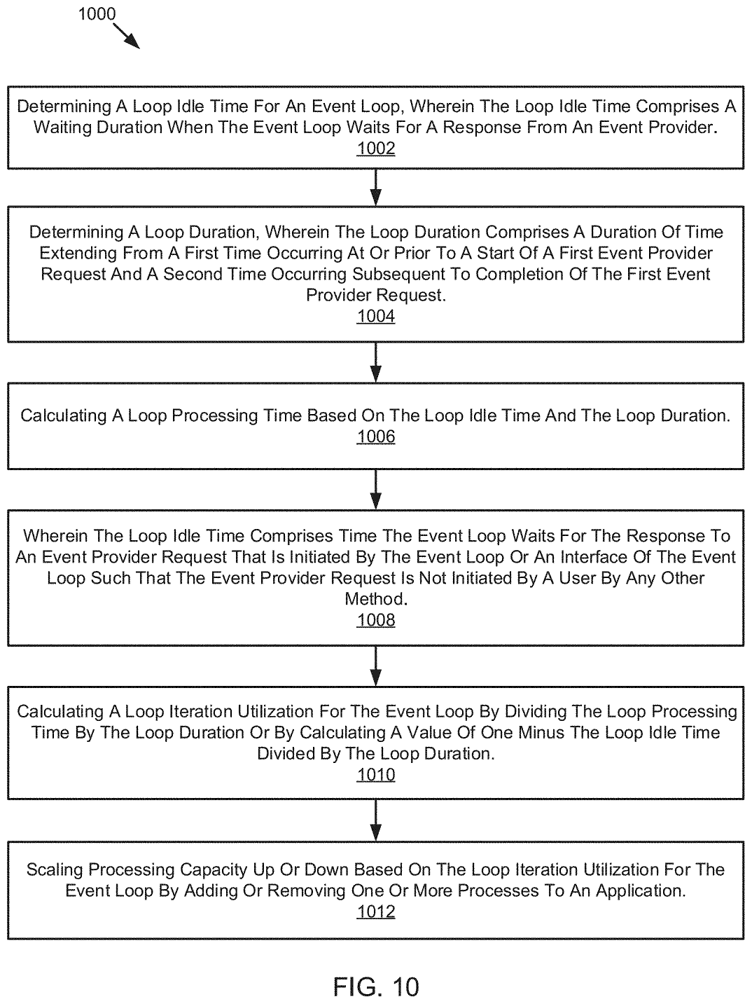

FIG. 10 is a schematic flow chart diagram of a method 1000 for scaling processing capacity up or down based on metrics determined for an event loop 114. The method 1000 may be performed by any suitable computing device. Such computing device may be in communication with an event loop 114 and/or may receive metrics determined based on activity of the event loop 114. The method 1000 may be particularly applied in an implementation wherein metrics for the event loop are determined based on non-timeseries data.

The method 1000 begins and a computing device determines at 1002 a loop idle time for an event loop, wherein the loop idle time comprises a waiting duration when the event loop waits for a response from an event provider. The computing device determines at 1004 a loop duration, wherein the loop duration comprises a duration of time extending from a first time occurring at or prior to a start of a first event provider request and a second time occurring subsequent to completion of the first event provider request. The computing device calculates at 1006 a loop processing time based on the loop idle time and the loop duration. The method 1000 is such that the loop idle time comprises time the event loop waits for the response to an event provider request that is initiated by the event loop or an interface of the event loop such that the event provider request is not initiated by a user by any other method (see 1008). The method 1000 continues and the computing device calculates at 1010 a loop iteration utilization for the event loop by dividing the loop processing time by the loop duration or by calculating a value of one minus the loop idle time divided by the loop duration. The computing device scales at 1012 processing capacity up or down based on the loop iteration utilization for the event loop by adding or removing one or more processes to an application.

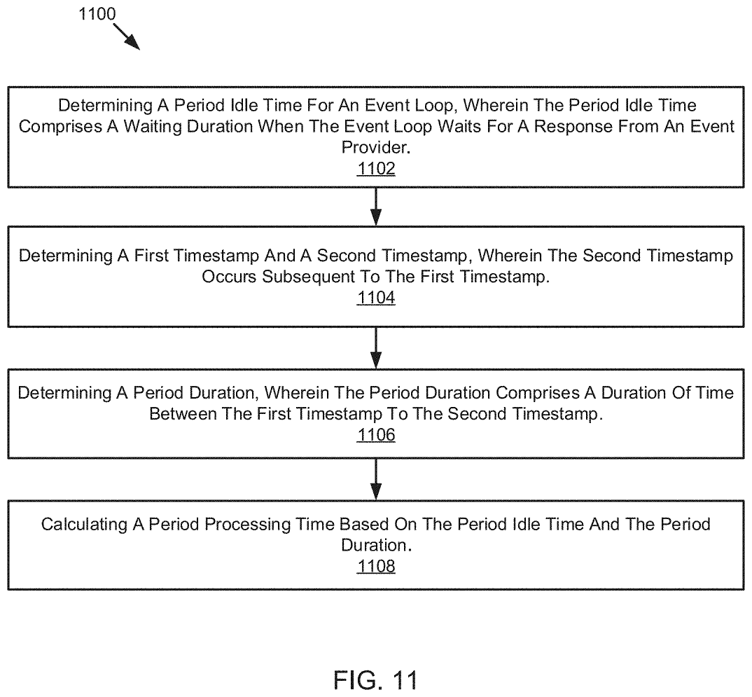

FIG. 11 is a schematic flow chart diagram of a method 1100 for determining a period processing time for an event loop 114. The method 1100 may be performed by any suitable computing device. Such computing device may be in communication with an event loop 114 and/or may receive metrics determined based on activity of the event loop 114. The method 1100 may be particularly applied in an implementation wherein metrics are determined for the event loop based on timeseries data.

The method 1100 begins and the computing device determines at 1102 a period idle time for an event loop, wherein the period idle time comprises a waiting duration when the event loop waits for a response from an event provider. The computing device determines at 1104 a first timestamp and a second timestamp, wherein the second timestamp occurs subsequent to the first timestamp. The computing device determines at 1106 a period duration, wherein the period duration comprises a duration of time between the first timestamp to the second timestamp. The computing device calculates at 1008 a period processing time based on the period idle time and the period duration.

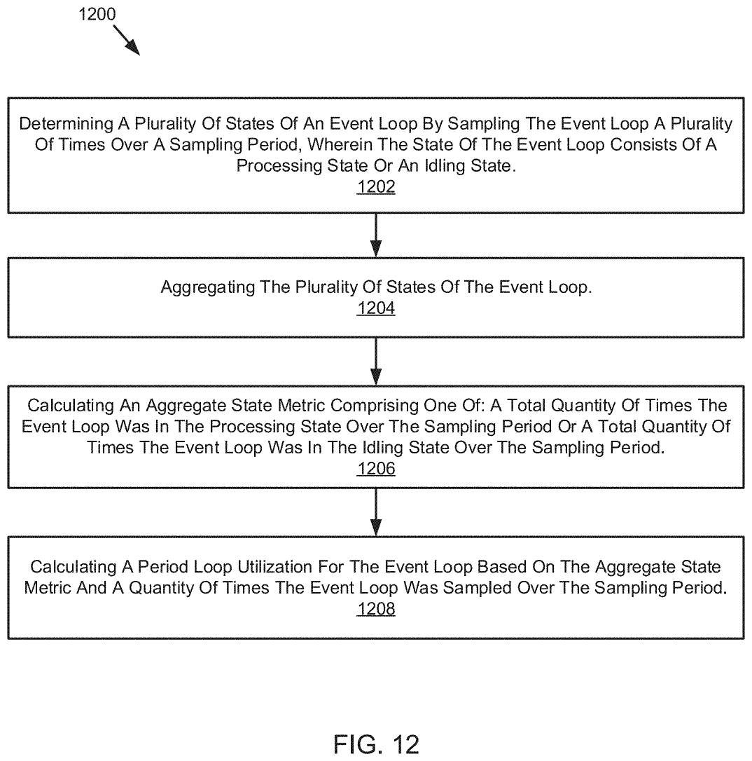

FIG. 12 is a schematic flow chart diagram of a method 1200 for determining an event loop load for an event loop 114. The method 1200 may be performed by any suitable computing device. Such computing device may be in communication with an event loop 114 and/or may receive metrics determined based on activity of the event loop 114. The method 1200 may be particularly applied in an implementation wherein metrics are determined for the event loop based on sampling.

The method 1200 begins and the computing device determines at 1202 a plurality of states of an event loop by sampling the event loop a plurality of times over a sampling period, wherein the state of the event loop consists of a processing state or an idling state. The computing device aggregates at 1204 the plurality of states of the event loop. The computing device calculates at 1206 an aggregate state metric comprising one of: a total quantity of times the event loop was in the processing state over the sampling period or a total quantity of times the event loop was in the idling state over the sampling period. The method 1200 continues and the computing device calculates at 1208 a period loop utilization for the event loop based on the aggregate state metric and a quantity of times the event loop was sampled over the sampling period.

In an embodiment, the event loop idle time includes time spent waiting for a response to an event provider request 116 only when the event provider request 116 is initiated by the event loop 114 itself or an interface of the event loop 114 such that the event provider request 116 is not initiated by a user by any other method. Further in such an embodiment, the event loop 114 may further include one or more user-initiated event provider requests 116 that are initiated by the user by some other method, and the loop idle time does not include the duration of time spent idling in those user-initiated event provider requests 116.

In an embodiment, the loop idle time includes time the event loop 114 waits for a response to an event provider request 116 when there is no available response from the event provider 118. Where there is an available response from the event provider 118, the loop idle time does not include the time spent retrieving the response.

In an embodiment, processing capacity of computing resources is scaled up or down in response to the event loop load metric that is determined based at least in part on the period processing time metric. In an embodiment, a user provides threshold values for event loop load for which an auto-scaling event occurs that adjusts computing resources up or down based on the event loop load metric.

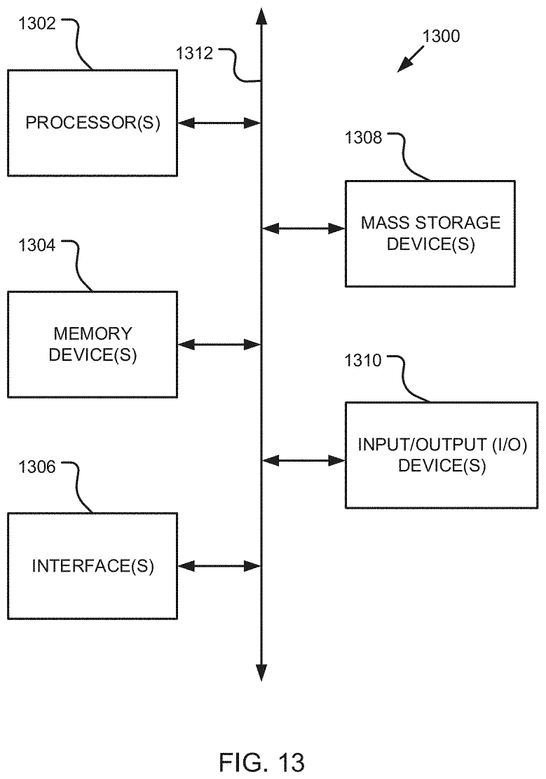

FIG. 13 is a block diagram depicting an example computing device 1300. In some embodiments, computing device 1300 is used to implement one or more of the systems and components discussed herein. Further, computing device 1300 may interact with any of the systems and components described herein. Accordingly, computing device 1300 may be used to perform various procedures and tasks, such as those discussed herein, including for example determining a processing time for an event loop. Computing device 1300 can function as a server, a client or any other computing entity. Computing device 1300 can be any of a wide variety of computing devices, such as a desktop computer, a notebook computer, a server computer, a handheld computer, a tablet, and the like.

Computing device 1300 includes one or more processor(s) 1302, one or more memory device(s) 1304, one or more interface(s) 1306, one or more mass storage device(s) 1308, and one or more Input/Output (1/O) device(s) 1310, all of which are coupled to a bus 1312. Processor(s) 1302 include one or more processors or controllers that execute instructions stored in memory device(s) 1304 and/or mass storage device(s) 1308. Processor(s) 1302 may also include various types of computer-readable media, such as cache memory.

Memory device(s) 1304 include various computer-readable media, such as volatile memory (e.g., random access memory (RAM)) and/or nonvolatile memory (e.g., read-only memory (ROM)). Memory device(s) 1304 may also include rewritable ROM, such as Flash memory.

Mass storage device(s) 1308 include various computer readable media, such as magnetic tapes, magnetic disks, optical disks, solid state memory (e.g., Flash memory), and so forth. Various drives may also be included in mass storage device(s) 1308 to enable reading from and/or writing to the various computer readable media. Mass storage device(s) 1308 include removable media and/or non-removable media.

I/O device(s) 1310 include various devices that allow data and/or other information to be input to or retrieved from computing device 1300. Example I/O device(s) 1310 include cursor control devices, keyboards, keypads, microphones, monitors or other display devices, speakers, printers, network interface cards, modems, lenses, CCDs or other image capture devices, and the like.

Interface(s) 1306 include various interfaces that allow computing device 1300 to interact with other systems, devices, or computing environments. Example interface(s) 1306 include any number of different network interfaces, such as interfaces to local area networks (LANs), wide area networks (WANs), wireless networks, and the Internet.

Bus 1312 allows processor(s) 1302, memory device(s) 1304, interface(s) 1306, mass storage device(s) 1308, and I/O device(s) 1310 to communicate with one another, as well as other devices or components coupled to bus 1312. Bus 1312 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1300 and are executed by processor(s) 1302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein. As used herein, the terms “module” or “component” are intended to convey the implementation apparatus for accomplishing a process, such as by hardware, or a combination of hardware, software, and/or firmware, for the purposes of performing all or parts of operations disclosed herein.

### Examples

The following examples pertain to further embodiments.

Example 1 is a method for determining a loop processing time of an event loop. The method may be used in an implementation where the loop processing time is calculated as non-timeseries data. The method includes determining a loop idle time for an event loop, wherein the loop idle time comprises a waiting duration when the event loop waits for a response from an event provider. The method includes determining a loop duration, wherein the loop duration comprises a duration of time extending from: a first time occurring at or prior to a start of a first event provider request; and a second time occurring subsequent to completion of the first event provider request. The method includes calculating a loop processing time based on the loop idle time and the loop duration.

Example 2 is a method as in Example 1, wherein the loop idle time comprises time the event loop waits for the response to an event provider request that is initiated by the event loop or an interface of the event loop such that the event provider request is not initiated by a user by any other method.

Example 3 is a method as in any of Examples 1-2, further comprising a second event provider request when the event loop waits for a second response from the event provider; wherein the second event provider request is not initiated by the event loop or the interface of the event loop; and wherein the loop idle time comprises the first event provider request and does not comprise the second event provider request.

Example 4 is a method as in any of Examples 1-3, wherein the loop idle time comprises time the event loop waits for a response from the event provider when there is no available event.

Example 5 is a method as in any of Examples 1-4, wherein the loop idle time does not comprise time spent receiving events from the event provider.

Example 6 is a method as in any of Examples 1-5, wherein calculating the loop processing time comprises subtracting the loop idle time from the loop duration.

Example 7 is a method as in any of Examples 1-6, further comprising determining whether a response from the event provider is available at the start of the first event provider request.

Example 8 is a method as in any of Examples 1-7, further comprising calculating a loop iteration utilization for the event loop by one or more of: dividing the loop processing time by the loop duration; or calculating a value of one minus the loop idle time divided by the loop duration.

Example 9 is a method as in any of Examples 1-8, further comprising scaling processing capacity up or down based on the loop iteration utilization for the event loop by adding or removing one or more processes to an application.

Example 10 is a method as in any of Examples 1-9, further comprising distributing processing load based on the loop iteration utilization for the event loop by directing one or more events to one or more other event loops or to one or more other processes.

Example 11 is a method as in any of Examples 1-10, further comprising converting the loop iteration utilization for the event loop to timeseries data, wherein the converting comprises: determining a period duration comprising a duration of time between a first timestamp and a second timestamp, wherein the second timestamp occurs subsequent to the first timestamp; determining a period idle time wherein the period idle time comprises time spent waiting for the response from the event provider as an aggregate of loop idle time during the period duration; and calculating a period processing time based on the period idle time and the period duration.

Example 12 is a method as in any of Examples 1-11, further comprising: calculating a period loop utilization by dividing the period processing time by the period duration; and calculating an event loop load by entering the period loop utilization into an exponential moving average for tracking the period loop utilization over time.

Example 13 is a method as in any of Examples 1-12, wherein, in response to determining that no event is available at the first timestamp, the period idle time duration comprises: a time duration extending from the first timestamp to a time when the event loop begins waiting for a response from an event provider; and a time duration extending from a time when the event loop ceases waiting for a response from an event provider to the second timestamp.

Example 14 is a method as in any of Examples 1-13, wherein, in response to determining that one or more events are available at the second timestamp, the period idle time duration comprises a time duration extending from the first timestamp to the second timestamp.

Example 15 non-transitory computer readable storage media storing instructions that, when executed by one or more processes, cause the one or more processes to: determine a loop idle time for an event loop, wherein the loop idle time comprises a waiting duration when the event loop waits for a response from an event provider; determine a loop duration, wherein the loop duration comprises a duration of time extending from: a first time occurring at or prior to a start of a first event provider request; and a second time occurring subsequent to completion of the first event provider request; and calculate a loop processing time based on the loop idle time and the loop duration.

Example 16 is non-transitory computer readable storage media as in Example 15, wherein the loop idle time comprises time the event loop waits for the response to an event provider request that is initiated by the event loop or an interface of the event loop such that the event provider request is not initiated by a user by any other method.

Example 17 is non-transitory computer readable storage media as in any of Examples 15-15, wherein the instructions further cause the one or more processes to calculate a loop iteration utilization for the event loop by one or more of: dividing the loop processing time by the loop duration; or calculating a value of one minus the loop idle time divided by the loop duration.

Example 18 is non-transitory computer readable storage media as in any of Examples 15-17, wherein the instructions further cause the one or more processes to one or more of: scale processing capacity up or down based on the loop iteration utilization for the event loop by adding or removing one or more processes to an application; or distribute processing load based on the loop iteration utilization for the event loop by directing one or more events to one or more other event loops or to one or more other processes.

Example 19 is non-transitory computer readable storage media as in any of Examples 15-18, wherein the instructions further cause the one or more processes to convert the loop iteration utilization for the event loop to timeseries data, wherein the converting comprises: determining a period duration comprising a duration of time between a first timestamp and a second timestamp, wherein the second timestamp occurs subsequent to the first timestamp; determining a period idle time wherein the period idle time comprises time spent waiting for the response from the event provider as an aggregate of loop idle time during the period duration; and calculating a period processing time based on the period idle time and the period duration.

Example 20 is non-transitory computer readable storage media as in any of Examples 15-19, wherein, in response to the one or more processes determining that no event is available at the first timestamp, the period idle time duration comprises: a time duration extending from the first timestamp to a time when the event loop begins waiting for a response from an event provider; and a time duration extending from a time when the event loop ceases waiting for a response from an event provider to the second timestamp. The example is such that further wherein, in response to the one or more processes determining that one or more events are available at the second timestamp, the period idle time comprises a time duration extending from the first timestamp to the second timestamp.

Example 21 is a system. The system includes means for determining a loop idle time for an event loop, wherein the loop idle time comprises a waiting duration when the event loop waits for a response from an event provider. The system includes means for determining a loop duration, wherein the loop duration comprises a duration of time extending from: a first time occurring at or prior to a start of a first event provider request; and a second time occurring subsequent to completion of the first event provider request. The system includes means for calculating a loop processing time based on the loop idle time and the loop duration.

Example 22 is a system as in Examples 21, wherein the loop idle time comprises time the event loop waits for the response to an event provider request that is initiated by the event loop or an interface of the event loop such that the event provider request is not initiated by a user by any other method.

Example 23 is a system as in any of Examples 21-22, further comprising means for calculating a loop iteration utilization for the event loop by one or more of: dividing the loop processing time by the loop duration; or calculating a value of one minus the loop idle time divided by the loop duration.

Example 24 is a system as in any of Examples 21-23, further comprising means for one or more of: scaling processing capacity up or down based on the loop iteration utilization for the event loop by adding or removing one or more processes to an application; or distributing processing load based on the loop iteration utilization for the event loop by directing one or more events to one or more other event loops or to one or more other processes.

Example 25 is a system as in any of Examples 21-24, further comprising means for converting the loop iteration utilization for the event loop to timeseries data, wherein the converting comprises: determining a period duration comprising a duration of time between a first timestamp and a second timestamp, wherein the second timestamp occurs subsequent to the first timestamp; determining a period idle time wherein the period idle time comprises time spent waiting for the response from the event provider as an aggregate of loop idle time during the period duration; and calculating a period processing time based on the period idle time and the period duration.

Example 26 is a system as in any of Examples 21-25, further comprising means for calculating an event loop load average by entering the period loop utilization into an exponential moving average for tracking the period loop utilization over time.

Example 27 is a system as in any of Examples 21-26, further comprising means for determining whether an event is available at the first timestamp and wherein, in response to determining that no event is available at the first timestamp, the period idle time duration comprises: a time duration extending from the first timestamp to a time when the event loop begins an event provider request; and a time duration extending from a time when the event loop ceases waiting for a response to the event provider request from the event provider, to the second timestamp.

Example 28 is a system as in any of Examples 21-27, further comprising means for determining whether an event is available at the second timestamp and wherein, in response to determining that one or more events are available at the second timestamp, the period idle time comprises a time duration extending from the first timestamp to the second timestamp.

Example 29 is a method for determining a period processing time. The method may be implemented for determining metrics as timeseries data. The method includes determining a period idle time for an event loop, wherein the period idle time comprises a waiting duration when the event loop waits for a response from an event provider. The method includes determining a first timestamp and a second timestamp, wherein the second timestamp occurs subsequent to the first timestamp. The method includes determining a period duration, wherein the period duration comprises a duration of time between the first timestamp to the second timestamp. The method includes calculating a period processing time based on the period idle time and the period duration.

Example 30 is a method as in Example 29, wherein the period idle time comprises time the event loop waits for the response to an event provider request that is initiated by the event loop or an interface of the event loop such that the event provider request is not initiated by a user by any other method.

Example 31 is a method as in any of Examples 29-30, wherein the period idle time comprises time the event loop waits for one or more responses from the event provider when there are no available events.

Example 32 is a method as in any of Examples 29-31, wherein the period idle time does not comprise time spent receiving one or more events from the event provider.

Example 33 is a method as in any of Examples 29-32, wherein calculating the period processing time comprises subtracting the period idle time from the period duration.

Example 34 is a method as in any of Examples 29-33, further comprising determining whether one or more responses from the event provider are available at a beginning of an event provider request.

Example 35 is a method as in any of Examples 29-34, wherein determining the period duration comprises determining by a thread other than a main event loop thread such that the determining the first timestamp and the second timestamp does not depend on execution by the main event loop thread.

Example 36 is a method as in any of Examples 29-35, further comprising calculating a period loop utilization by dividing the period processing time by the period duration.

Example 37 is a method as in any of Examples 29-36, further comprising calculating a period loop utilization by calculating a value of one minus the period idle time divided by the period duration.

Example 38 is a method as in any of Examples 29-37, further comprising: calculating a period loop utilization for the event loop based on two metrics from a group consisting of the period idle time, the period duration, and the period processing time; and scaling processing capacity up or down based on the period loop utilization for the event loop by adding or removing one or more processes to an application.

Example 39 is a method as in any of Examples 29-38, further comprising: calculating a period loop utilization for the event loop based on two metrics from a group consisting of the period idle time, the period duration, and the period processing time; and distributing processing load based on the period loop utilization for the event loop by directing one or more events to one or more other event loops or to one or more other processes.

Example 40 is a method as in any of Examples 29-39, further comprising: calculating a period loop utilization for the event loop based on two metrics from a group consisting of the period idle time, the period duration, and the period processing time; and calculating an event loop load for the event loop by entering the period loop utilization into an exponential moving average for tracking the period loop utilization over time.

Example 41 is a method as in any of Examples 29-40, further comprising one or more of: scaling processing capacity up or down based on the event loop load for the event loop, wherein scaling the processing capacity comprises adding or removing one or more processes to an application; or distributing processing load based on the event loop load for the event loop by directing one or more events to one or more other event loops or to one or more other processes.

Example 42 is a system. The system includes means for determining a period idle time for an event loop, wherein the period idle time comprises a waiting duration when the event loop waits for a response from an event provider. The system includes means for determining a first timestamp and a second timestamp, wherein the second timestamp occurs subsequent to the first timestamp. The system includes means for determining a period duration, wherein the period duration comprises a duration of time between the first timestamp to the second timestamp. The system includes means for calculating a period processing time based on the period idle time and the period duration.

Example 43 is a system as in Example 42, wherein the period idle time comprises time the event loop waits for the response to an event provider request that is initiated by the event loop or an interface of the event loop such that the event provider request is not initiated by a user by any other method, and wherein the period idle time does not comprise time spent receiving one or more events from the event provider.

Example 44 is a system as in any of Examples 42-43, wherein the means for determining the period duration is configured to determine by a thread other than a main event loop thread such that determining the first timestamp and the second timestamp does not depend on execution by the main event loop thread.

Example 45 is a system as in any of Examples 42-44, further comprising: means for calculating a period loop utilization for the event loop based on two metrics from a group consisting of the period idle time, the period duration, and the period processing time; and means for scaling processing capacity up or down based on the period loop utilization for the event loop by adding or removing one or more processes to an application.

Example 46 is a system as in any of Examples 42-45, further comprising: means for calculating a period loop utilization for the event loop based on two metrics from a group consisting of the period idle time, the period duration, and the period processing time; and means for distributing processing load based on the period loop utilization for the event loop by directing one or more events to one or more other event loops or to one or more other processes.

Example 47 is non-transitory computer readable storage media storing instructions that, when executed by one or more processes, cause the one or more processes to: determine a period idle time for an event loop, wherein the period idle time comprises a waiting duration when the event loop waits for a response from an event provider; determine a first timestamp and a second timestamp, wherein the second timestamp occurs subsequent to the first timestamp; determine a period duration, wherein the period duration comprises a duration of time between the first timestamp to the second timestamp; and calculate a period processing time based on the period idle time and the period duration.

Example 48 is non-transitory computer readable storage media as in Example 47, wherein the instructions cause the one or more processes to calculate a period loop utilization for the event loop based on two metrics from a group consisting of the period idle time, the period duration, and the period processing time, and further cause the one or more processes to one or more of: scale processing capacity up or down based on the period loop utilization for the event loop by adding or removing one or more processes to an application; or distribute processing load based on the period loop utilization for the event loop by directing one or more events to one or more other event loops or to one or more other processes.

Example 49 is a method. The method may be implemented for determining metrics for an event loop using a sampling implementation. The method includes determining a plurality of states of an event loop by sampling the event loop a plurality of times, wherein the state of the event loop consists of a processing state or an idling state. The method includes aggregating the plurality of states of the event loop. The method includes calculating an aggregate state metric comprising one of a total quantity of times the event loop was in the processing state or a total quantity of times the event loop was in the idling state. The method includes calculating a period loop utilization for the event loop based on the aggregate state metric and a quantity of the plurality of times the event loop was sampled.

Example 50 is a method as in Example 49, wherein sampling the event loop the plurality of times comprises sampling for a duration of a predefined sampling period and repeating the sampling period a predefined number of times.

Example 51 is a method as in any of Examples 49-50, wherein the processing state indicates the event loop is not waiting for a response from an event provider.

Example 52 is a method as in any of Examples 49-51, wherein the idling state indicates the event loop is waiting for a response from an event provider and does not comprise an instance when the event loop is receiving a response from the event provider.

Example 53 is a method as in any of Examples 49-52, further comprising scaling processing capacity up or down based on the period loop utilization for the event loop by adding or removing one or more processes to an application.

Example 54 is a method as in any of Examples 49-53, further comprising distributing processing load based on the period loop utilization for the event loop by directing one or more events to one or more other event loops or to one or more other processes.

Example 55 is a method as in any of Examples 49-54, wherein calculating the period loop utilization for the event loop comprises dividing the aggregate state metric by the quantity of the plurality of times the event loop was sampled.

Example 56 is a method as in any of Examples 49-55, further comprising calculating an event loop load by entering the period loop utilization into an exponential moving average for tracking the period loop utilization over time.

Example 57 is a method as in any of Examples 49-56, further comprising one or more of: scaling processing capacity up or down based on the event loop load by adding or removing one or more processes to an application; or distributing processing load based on the event loop load by directing one or more events to one or more other event loops or to one or more other processes.

Example 58 is a method as in any of Examples 49-57, wherein the sampling the event loop is performed by an internal agent running on a separate thread.

Example 59 is a system. The system includes means for determining a plurality of states of an event loop by sampling the event loop a plurality of times, wherein the state of the event loop consists of a processing state or an idling state. The system includes means for aggregating the plurality of states of the event loop. The system includes means for calculating an aggregate state metric comprising one of a total quantity of times the event loop was in the processing state or a total quantity of times the event loop was in the idling state. The system includes means for calculating a period loop utilization for the event loop based on the aggregate state metric and a quantity of the plurality of times the event loop was sampled.

Example 60 is a system as in Example 59, wherein the idling state indicates the event loop is waiting for a response from an event provider and does not comprise an instance when the event loop is receiving a response from the event provider.

Example 61 is a system as in any of Examples 59-60, further comprising one or more of: means for scaling processing capacity up or down based on the period loop utilization for the event loop by adding or removing one or more processes to an application; or means for distributing processing load based on the period loop utilization for the event loop by directing one or more events to one or more other event loops or to one or more other processes.

Example 62 is a system as in any of Examples 59-61, further comprising means for calculating an event loop load by entering the period loop utilization into an exponential moving average for tracking the period loop utilization over time.

Example 63 is a system as in any of Examples 59-62, further comprising one or more of: means for scaling processing capacity up or down based on the event loop load by adding or removing one or more processes to an application; or means for distributing processing load based on the event loop load by directing one or more events to one or more other event loops or to one or more other processes.

Example 64 is non-transitory computer readable storage media storing instructions that, when executed by one or more processes, cause the one or more processes to: determine a plurality of states of an event loop by sampling the event loop a plurality of times, wherein the state of the event loop consists of a processing state or an idling state; aggregate the plurality of states of the event loop; calculate an aggregate state metric comprising one of: a total quantity of times the event loop was in the processing state; or a total quantity of times the event loop was in the idling state; and calculate a period loop utilization for the event loop based on the aggregate state metric and a quantity of the plurality of times the event loop was sampled.

Example 65 is non-transitory computer readable storage media as in Example 64, wherein the instructions further cause the one or more processes to one or more of: scale processing capacity up or down based on the period loop utilization for the event loop by adding or removing one or more processes to an application; or distribute processing load based on the period loop utilization for the event loop by directing one or more events to one or more other event loops or to one or more other processes.

Example 66 is non-transitory computer readable storage media as in any of Examples 64-65, wherein the instructions further cause the one or more processes to calculate an event loop load by entering the period loop utilization into an exponential moving average for tracking the period loop utilization over time.

Example 67 is non-transitory computer readable storage media as in any of Examples 64-66, wherein the instructions further cause the one or more processes to one or more of: scale processing capacity up or down based on the event loop load by adding or removing one or more processes to an application; or distribute processing load based on the event loop load by directing one or more events to one or more other event loops or to one or more other processes.

Example 68 is non-transitory computer readable storage media as in any of Examples 64-67, wherein the instructions cause the one or more processes to calculate the period loop utilization for the event loop by dividing the aggregate state metric by the quantity of the plurality of times the event loop was sampled.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processes. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A method comprising:
determining a plurality of states of an event loop by sampling the event loop a plurality of times over a sampling period, wherein the state of the event loop consists of a processing state or an idling state;
aggregating the plurality of states of the event loop;
calculating an aggregate state metric comprising one of:
a total quantity of times the event loop was in the processing state over the sampling period; or
a total quantity of times the event loop was in the idling state over the sampling period; and
calculating a period loop utilization for the event loop based on the aggregate state metric and a quantity of times the event loop was sampled over the sampling period.

2. The method of claim 1, wherein determining the plurality of states of the event loop comprises sampling the event loop over a plurality of sampling periods, wherein the event loop is sampled a plurality of times for each sampling period of the plurality of sampling periods.

3. The method of claim 1, wherein the processing state indicates the event loop is not waiting for a response from an event provider.

4. The method of claim 1, wherein the idling state indicates the event loop is waiting for a response from an event provider and does not comprise an instance when the event loop is receiving a response from the event provider.

5. The method of claim 1, further comprising scaling processing capacity up or down based on the period loop utilization for the event loop by adding or removing one or more processes to an application.

6. The method of claim 1, further comprising distributing processing load based on the period loop utilization for the event loop by directing one or more events to one or more other event loops or to one or more other processes.

7. The method of claim 1, wherein calculating the period loop utilization for the event loop comprises dividing the total quantity of times the event loop was in the processing state over the sampling period by the quantity of times the event loop was sampled over the sampling period.

8. The method of claim 1, further comprising calculating an event loop load by entering the period loop utilization into an exponential moving average for tracking the period loop utilization over time.

9. The method of claim 8, further comprising one or more of:
scaling processing capacity up or down based on the event loop load by adding or removing one or more processes to an application; or
distributing processing load based on the event loop load by directing one or more events to one or more other event loops or to one or more other processes.

10. The method of claim 1, wherein the sampling the event loop is performed by an internal agent running on a separate thread.

11. A system comprising:
means for determining a plurality of states of an event loop by sampling the event loop a plurality of times over a sampling period, wherein the state of the event loop consists of a processing state or an idling state;
means for aggregating the plurality of states of the event loop;
means for calculating an aggregate state metric comprising one of:
a total quantity of times the event loop was in the processing state over the sampling period; or
a total quantity of times the event loop was in the idling state over the sampling period; and
means for calculating a period loop utilization for the event loop based on the aggregate state metric and a quantity of times the event loop was sampled over the sampling period.

12. The system of claim 11, wherein the idling state indicates the event loop is waiting for a response from an event provider and does not comprise an instance when the event loop is receiving a response from the event provider.

13. The system of claim 11, further comprising one or more of:
means for scaling processing capacity up or down based on the period loop utilization for the event loop by adding or removing one or more processes to an application; or
means for distributing processing load based on the period loop utilization for the event loop by directing one or more events to one or more other event loops or to one or more other processes.

14. The system of claim 11, further comprising means for calculating an event loop load by entering the period loop utilization into an exponential moving average for tracking the period loop utilization over time.

15. The system of claim 14, further comprising one or more of:
means for scaling processing capacity up or down based on the event loop load by adding or removing one or more processes to an application; or
means for distributing processing load based on the event loop load by directing one or more events to one or more other event loops or to one or more other processes.

16. Non-transitory computer readable storage media storing instructions that, when executed by one or more processors, cause the one or more processors to:
determine a plurality of states of an event loop by sampling the event loop a plurality of times over a sampling period, wherein the state of the event loop consists of a processing state or an idling state;
aggregate the plurality of states of the event loop;
calculate an aggregate state metric comprising one of:
a total quantity of times the event loop was in the processing state over the sampling period; or
a total quantity of times the event loop was in the idling state over the sampling period; and
calculate a period loop utilization for the event loop based on the aggregate state metric and a quantity of times the event loop was sampled over the sampling period.

17. The non-transitory computer readable storage media of claim 16, wherein the instructions further cause the one or more processors to one or more of:
scale processing capacity up or down based on the period loop utilization for the event loop by adding or removing one or more processes to an application; or
distribute processing load based on the period loop utilization for the event loop by directing one or more events to one or more other event loops or to one or more other processes.

18. The non-transitory computer readable storage media of claim 16, wherein the instructions further cause the one or more processors to calculate an event loop load by entering the period loop utilization into an exponential moving average for tracking the period loop utilization over time.

19. The non-transitory computer readable storage media of claim 18, wherein the instructions further cause the one or more processors to one or more of:
scale processing capacity up or down based on the event loop load by adding or removing one or more processes to an application; or
distribute processing load based on the event loop load by directing one or more events to one or more other event loops or to one or more other processes.

20. The non-transitory computer readable storage media of claim 16, wherein the instructions cause the one or more processors to calculate the period loop utilization for the event loop by dividing the total quantity of times the event loop was in the processing state over the sampling period by the quantity of times the event loop was sampled over the sampling period.
